(19) United States
(12) Patent Application Publication
(10) Pub. No.: US 2014/0100039 A1
(43) Pub. Date: Apr. 10, 2014

(54) Legacy Game Download and Configuration

(71) Applicant: Bally Gaming, Inc., Las Vegas, NV (US)

(72) Inventors: Thomas Scott, Henderson, NV (US); Christopher D. Barton, Henderson, NV (US); Mettu Ramakrishna Reddy, Marshfield, WI (US)

(73) Assignee: Bally Gaming, Inc., Las Vegas, NV (US)

(21) Appl. No.: 14/043,489

(22) Filed: Oct. 1, 2013

Related U.S. Application Data
(63) Continuation of application No. 13/280,087, filed on Oct. 24, 2011, now abandoned.
(60) Provisional application No. 61/406,028, filed on Oct. 22, 2010.

(51) Int. Cl. A63F 13/12

(52) U.S. Cl. CPC A63F 13/12
USPC 463/42

(57) ABSTRACT

A system includes a download configuration host server coupled to an electronic gaming machine which, in turn, comprises an operating system. A method for configuring a legacy game application on the electronic gaming machine comprises the following steps. A downloadable package comprising a game image of the legacy game and a game descriptor file is generated. The downloadable package is communicated from the download configuration host server to the electronic gaming machine. The legacy game image is installed on the electronic gaming machine. The installed legacy game is configured by the operating system. The operating system simulates configuration of the installed legacy game by an operator in response to data in the game descriptor file. The installed legacy game is then enabled for game play.

### CROSS-REFERENCE TO RELATED APPLICATION

This application is a continuation application of U.S. patent application Ser. No. 13/280,087 filed Oct. 24, 2011 and titled “Legacy Game Download and Configuration” which claims the benefit of prior filed U.S. Provisional Patent Application Ser. No. 61/406,028 filed Oct. 22, 2010 and titled “Legacy Game Download and Configuration”.

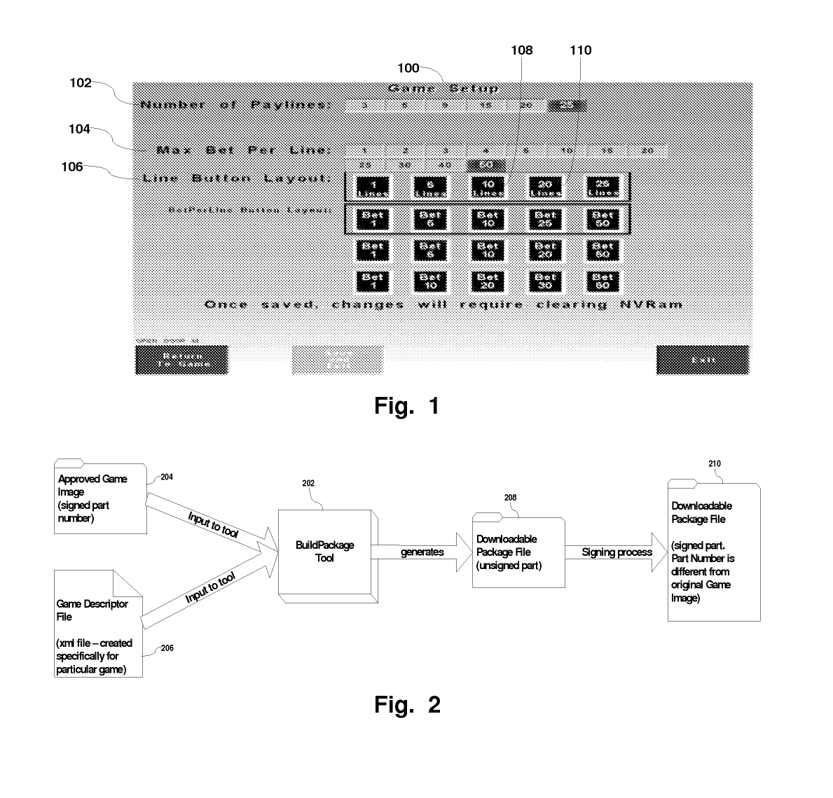

FIG. 1 is a screen display illustrating a game setup menu for a legacy game;

FIG. 2 is a flow diagram illustrating the process for creating a download package for legacy games according to principles of the present invention;

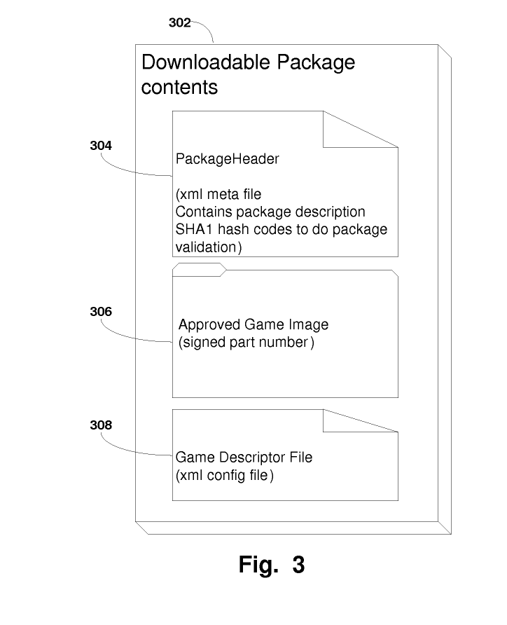

FIG. 3 is a content diagram illustrating the contents of a downloadable package for a legacy game according to principles of the present invention;

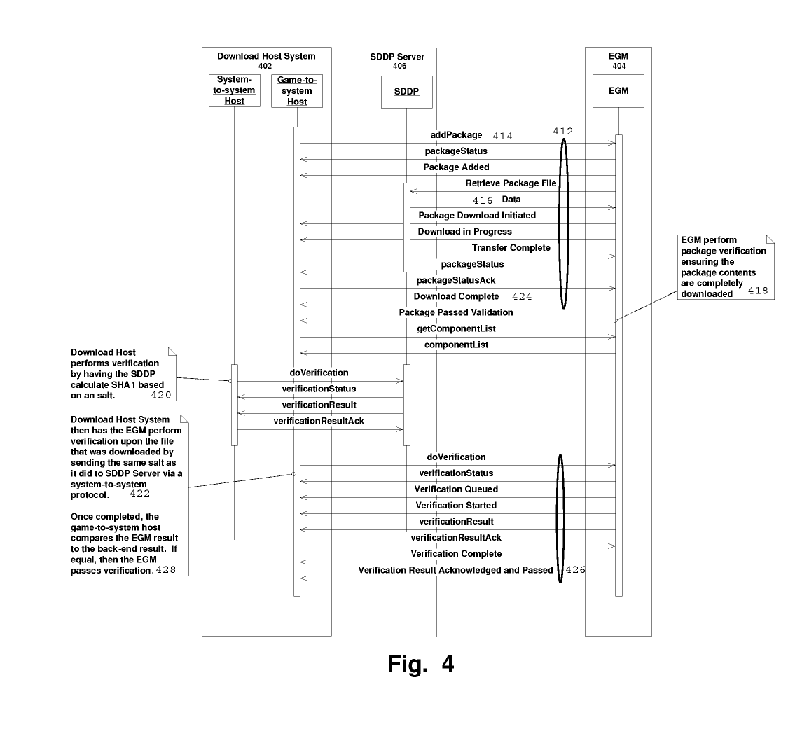

FIG. 4 is a sequence diagram illustrating the process of downloading a downloadable package as illustrated in FIG. 3 to a gaming machine according to principles of the present invention;

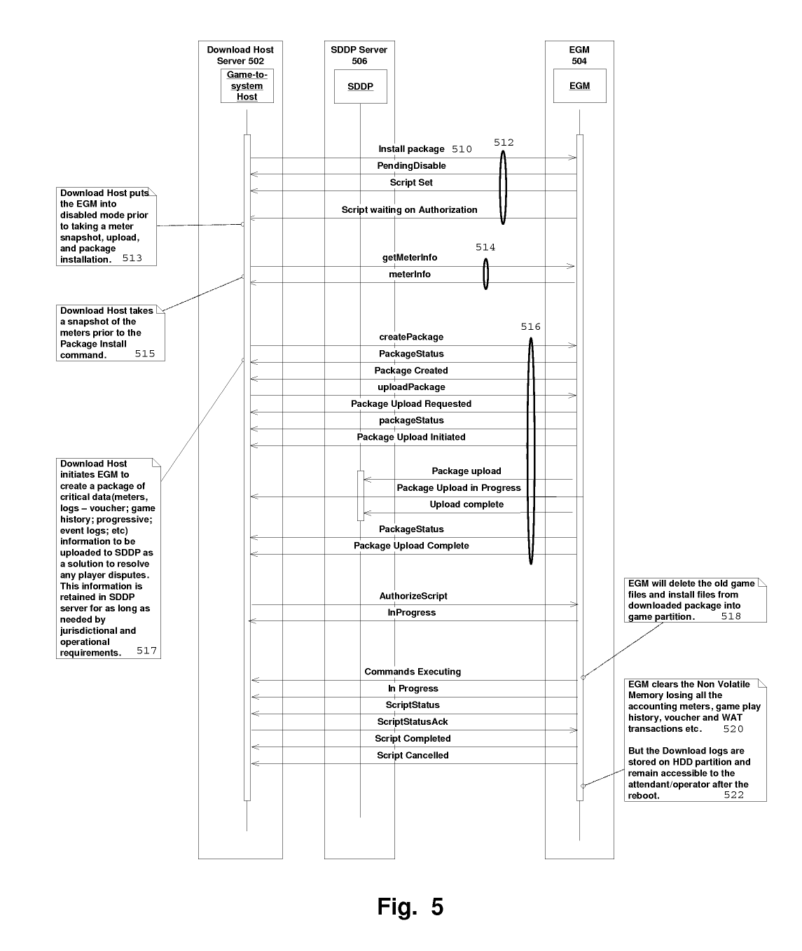

FIG. 5 is a sequence diagram illustrating the process of installing a legacy game contained in a downloadable package as illustrated in FIG. 3 in a gaming machine according to principles of the present invention;

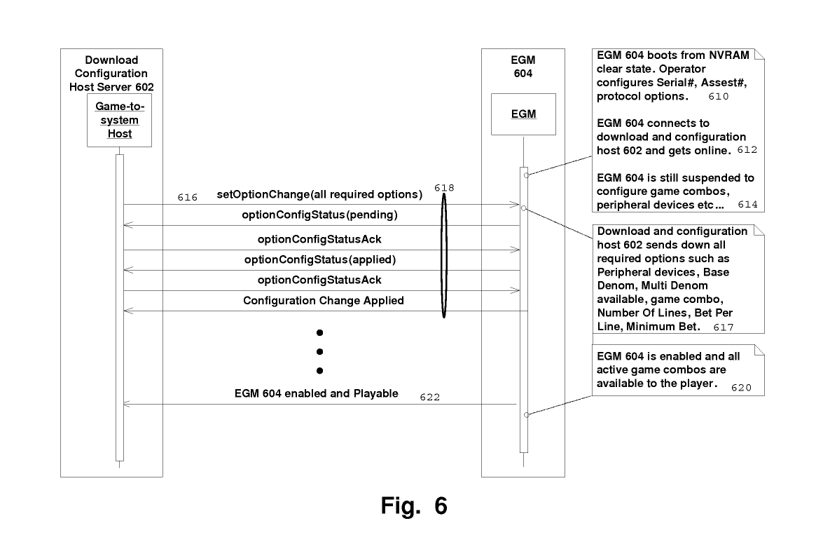

FIG. 6 is a sequence diagram illustrating the process of performing initial configuration of a legacy game previously installed in a gaming machine from a downloadable package as illustrated in FIG. 3 according to principles of the present invention;

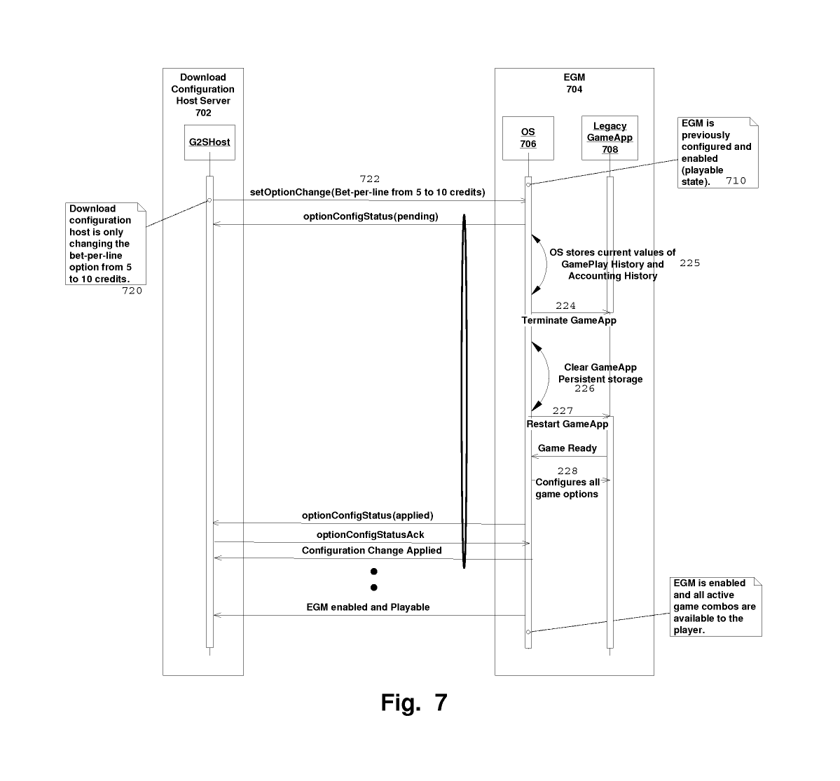

FIG. 7 is a sequence diagram illustrating the process of reconfiguring a legacy game previously installed in a gaming machine from a downloadable package as illustrated in FIG. 3 according to principles of the present invention;

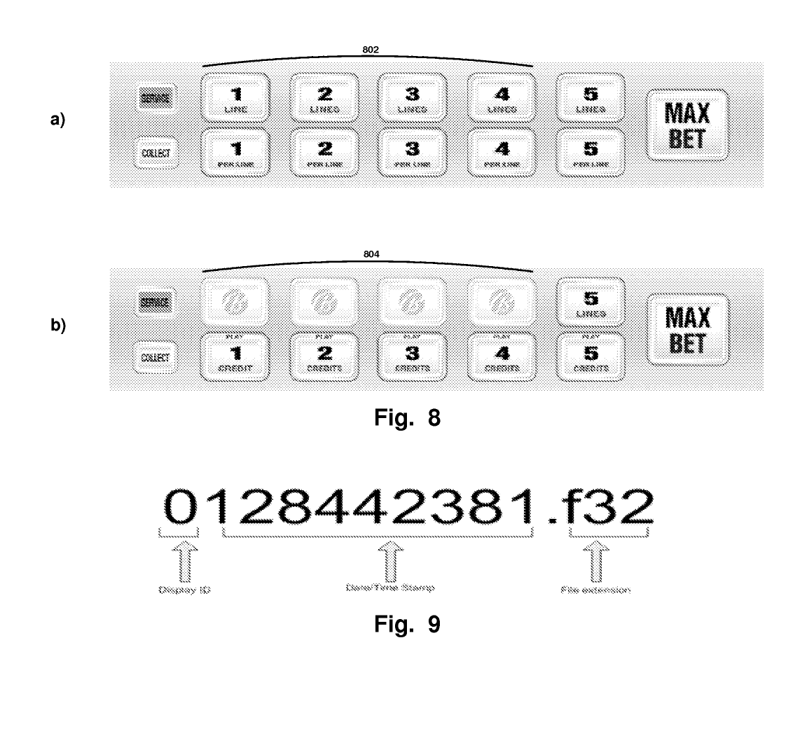

FIG. 8a and b are screen displays illustrating a button panel displayed by a legacy game previously installed in a gaming machine from a downloadable package as illustrated in FIG. 3 in a first and second configuration, respectively, as reconfigured according to principles of the present invention

FIG. 9 is a diagram illustrating the format of a file name for archiving game play history for a legacy game according to principles of the present invention;

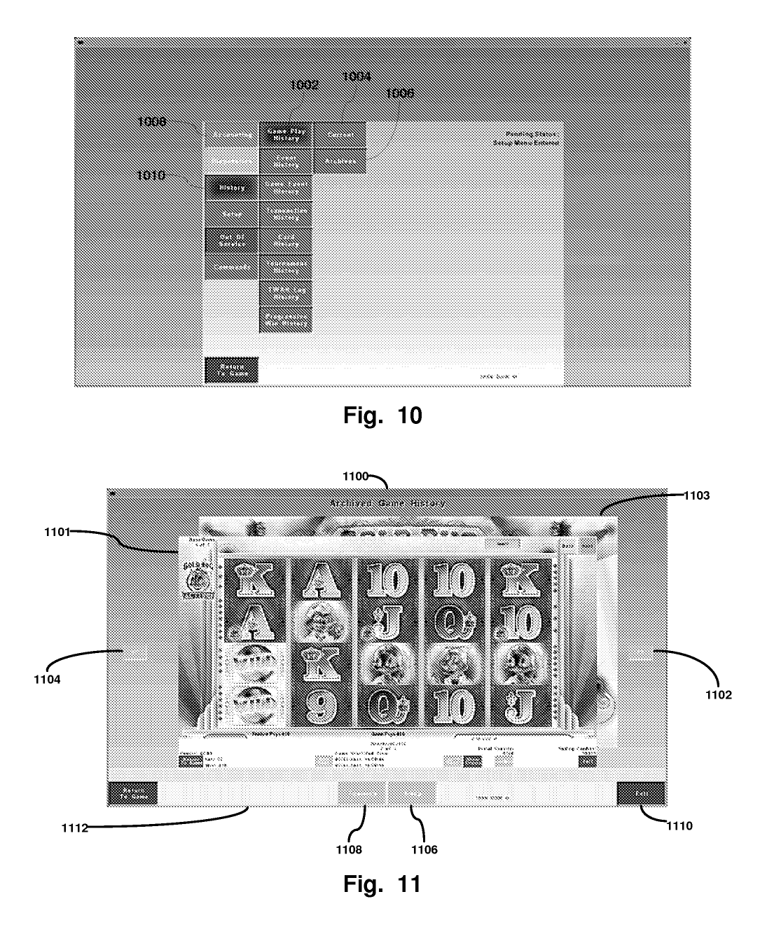

FIG. 10 is a screen display illustrating the location of icons on a game play history selection screen on a legacy game according to principles of the present invention;

FIG. 11 is a screen display illustrating images representing the contents of a game play history file according to principles of the present invention;

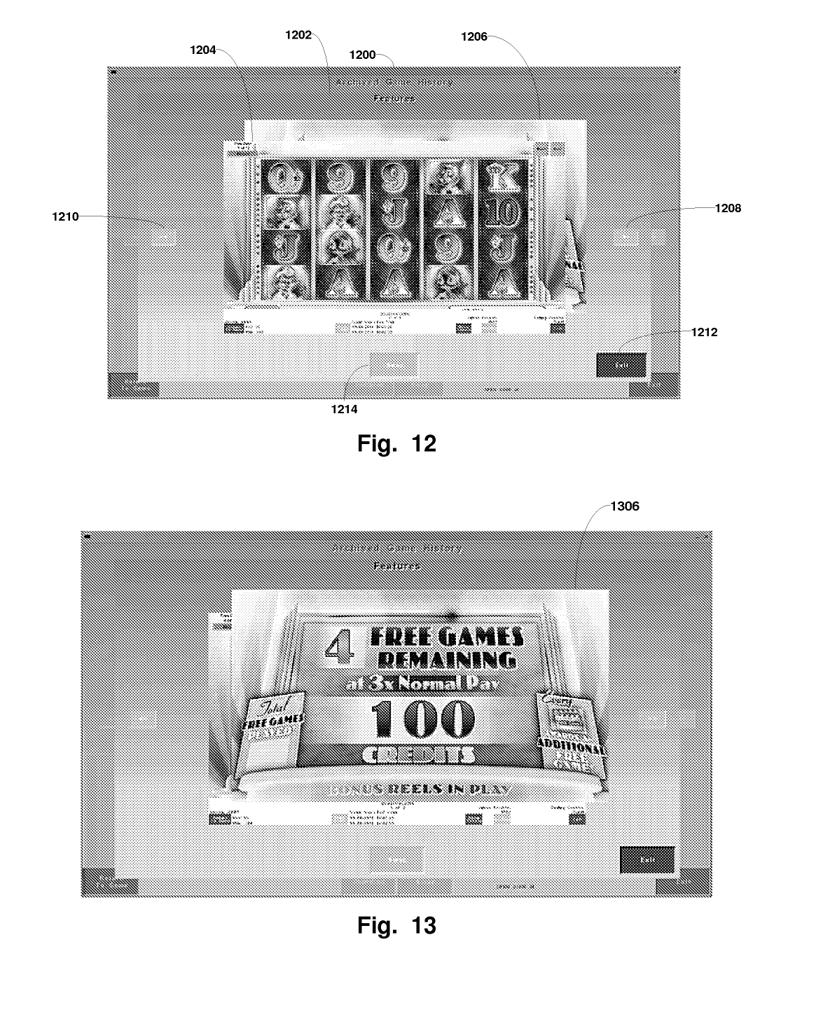

FIG. 12 is a screen display illustrating images representing the features active in main screen in a game play history file according to principles of the present invention;

FIG. 13 is a screen display illustrating images representing the features active in an upper screen in a game play history file according to principles of the present invention;

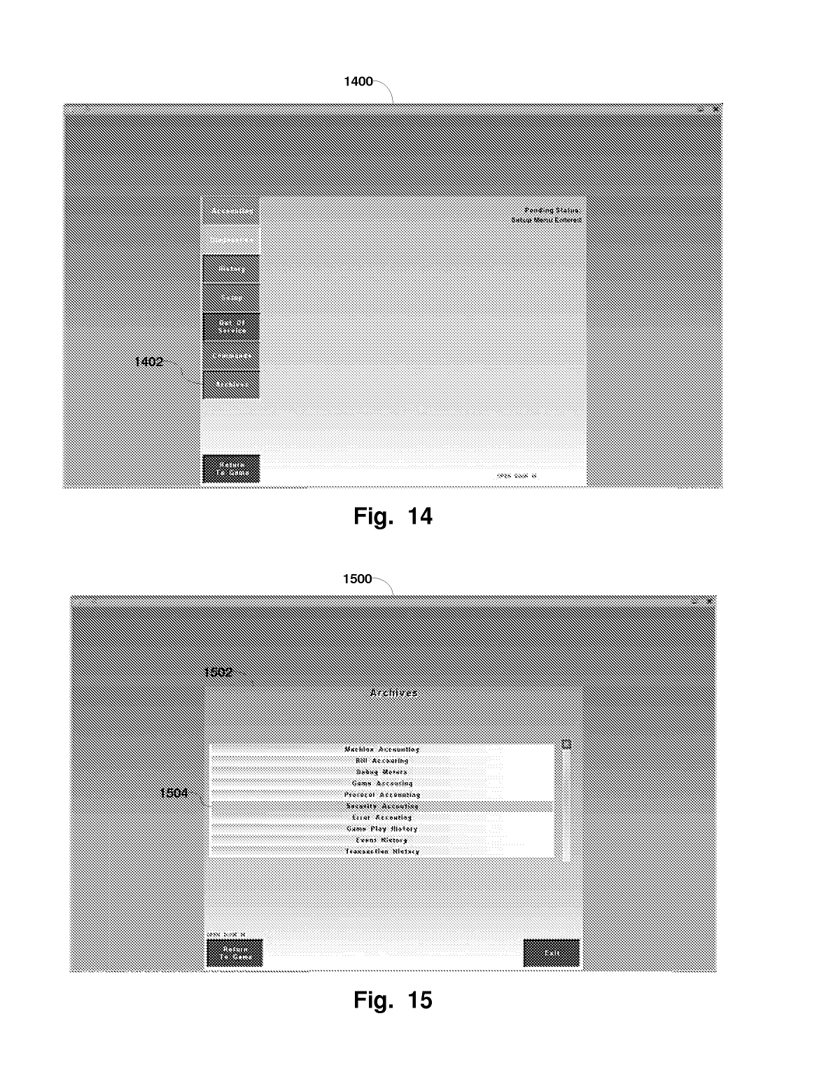

FIG. 14 is a screen display illustrating the location of icons on an operating system status screen according to principles of the present invention;

FIG. 15 is a screen display illustrating the location of buttons on an operating system archive selection screen according to principles of the present invention;

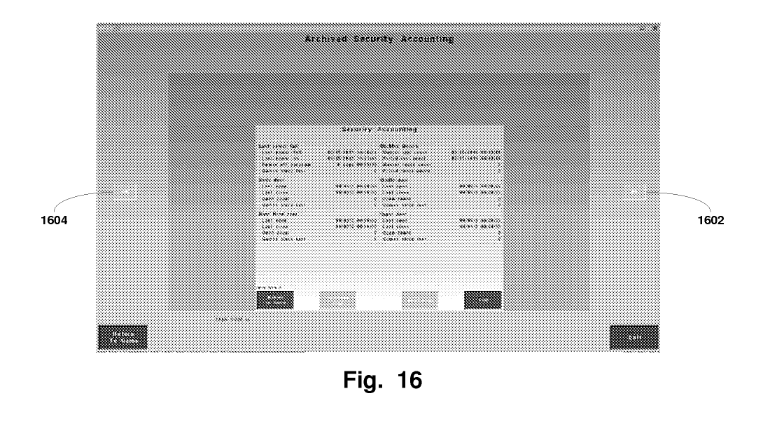

FIG. 16 is a screen display illustrating security accounting information according to principles of the present invention; and

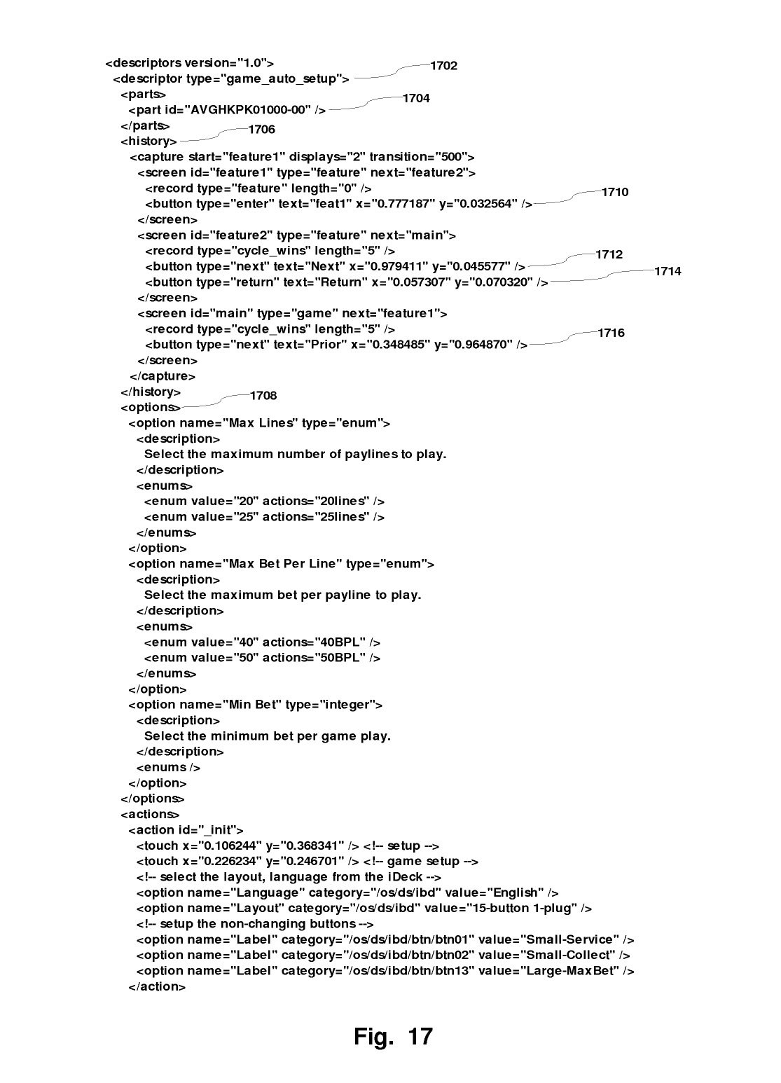

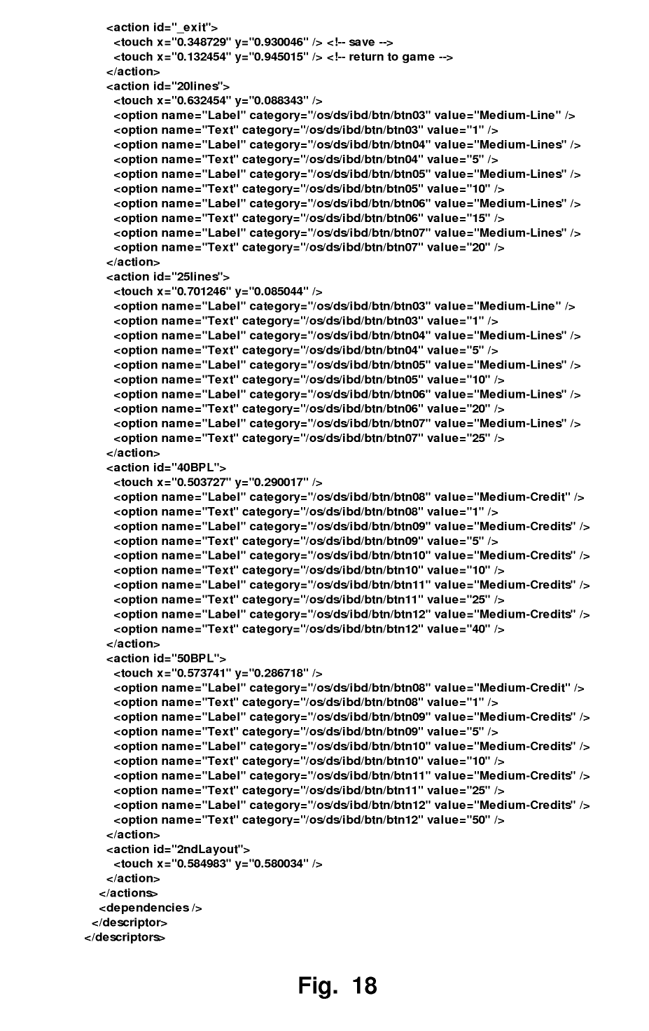

FIG. 17 and FIG. 18 combined is a listing of a game descriptor file which is part of a downloadable package according to principles of the present invention.

Typically, a legacy game requires its options to be configured during initial installation on an EGM before the game to become enabled and playable. The value of these options are typically displayed by the legacy game on an operator menu screen. FIG. 1 is a screen display 100 illustrating an example of such a menu screen entitled “Game Setup”. As illustrated in FIG. 1, typical options which may be configured include “Number of Paylines” 102, “Max Bet per Line” 104, “Line Button Layout” 106, and so forth.” Other options, not shown to simplify the figure, may include “Max Lines”, “Double up” and “Video Output”, etc. The game specific menu screen 100 is displayed and controlled by the legacy game software directly. In legacy game machines, these options are accessed by an operator by touching the screen at the location of the button desired to operate.

For the new operating system (OS) to support download and configuration of legacy games from e.g. a remote host, the OS needs information related to the display of the option selectors on the game setup display screens such as screen 100. This permits access to those game setup display screens to change of these options as desired. The Game Descriptor File (GDF) is an xml file that is created for the legacy game and contains information related to the display of game options on the Game Setup menu. FIG. 17 and FIG. 18 display a listing of a sample Game Descriptor File, and will be described in more detail below.

Referring to FIG. 2, a build package tool 202 receives an approved legacy game image 204 and the game descriptor file 206 as input data. The build package tool 202 generates an unsigned downloadable package file 208 as output data. This download package is then cryptographically signed to prevent undetected modification to produce a signed downloadable package file 210. The signed downloadable package file 210 is downloaded to, and installed on, an EGM to permit the legacy game represented by the approved game image 204 to be played on the EGM.

Referring to FIG. 3, a downloadable package file 302 includes data 304 representing a package header. The package header 304 includes data representing a package description, hash codes for the downloadable package and other portions of the downloadable package. These hash codes are used to perform package verification of the package in a known manner. The downloadable package file also includes data representing the approved legacy game image 306 and the game descriptor file 308 associated with the legacy game image 306.

Referring to FIG. 4, various request, reply, transfer, command, status, and acknowledgement messages are exchanged among the download host system 402, the SDDP server 406 and the EGM 404 to implement the legacy game package download, verification and operation, as described in detail below. When a download task is scheduled in the download host system 402, it initiates the download 412 by sending a request 414 to add a download package (i.e. a legacy game) to the EGM 404, i.e. to transfer a specific game package from the SDDP server 406 to the EGM 404. The EGM 404 starts downloading the file 416 from the SDDP server 406. In one embodiment, this download may be performed through secure http (https) connection. Other protocols and connections may also be used. One skilled in the art understands how to select and implement a transfer protocol.

After the game package is downloaded 424, the EGM 404 performs a validation 418 of the package received from the SDDP server 406 to ensure that the download package is downloaded to the EGM 404 completely and without errors. In the illustrated embodiment, this is done using the known technique of calculating a result of a one-way function, e.g. a cryptographic hash function, applied to the downloaded file and comparing it to the expected value of the one-way function found in the package header 304 (of FIG. 3). If they are the same, then the file was downloaded in full and accurately.

In a legacy game package download process, the EGM stores the legacy game image, i.e. the approved signed part, 306 (of FIG. 3) in the game partition of the hard-disk drive (not shown) in the EGM. The game descriptor file, i.e. the xml file that describes game options 308 is stored in the critical-data partition, e.g./critical_data/descriptors of the hard-disk in the EGM 504. The installation process involves retrieving the legacy game image from the hard-disk drive and loading it into the memory of the EGM in anticipation of being executed.

Referring to FIG. 5, after the game package is downloaded, the download host server 502 will send an install command 510 to the EGM 504 to install the package. Based on jurisdictional requirements of game idle time and zero credit conditions and so forth, EGM 504 will start installation of the package when those requirements are satisfied. When the conditions are met, the download host server 502 places the EGM 504 into the disabled mode 512, 513.

Before installation of the downloaded package, EGM 504 provides a snapshot 514, 515 of meter data related to game play history, as described below in FIG. 9, FIG. 10, FIG. 11, FIG. 12 and FIG. 13 and the associated written description below. The EGM 504 also requests 516, 517 a package of data related to accounting and/or transaction history, as described in FIG. 14, FIG. 15, and FIG. 16 and the associated written description below. The data is uploaded to the SDDP server 506, and archived in relatively long term storage. It may be used to resolve player disputes after the legacy game is installed in the EGM 504. The files associated with the downloaded legacy game are then retrieved from the hard disk drive and installed 518 into the memory of the EGM 504.

To activate the newly downloaded legacy game, the EGM 504 performs an automatic processor reset. During the reboot process, the OS locates the game descriptor file (FIG. 3, 308) associated with the legacy game to be installed on the hard disk drive, and reads all the options from the xml file. Because data representing the screens presenting the configuration data, and the locations of buttons and/or other widgets on those screens is specified in the game descriptor file 308, the EGM 504 gets access to the game options. In one embodiment, this may be done through use of the G2S OptionConfig device, as is known. Other methods for performing this function exist, and one skilled in the art understands how to select, and to design and implement such methods, as appropriate.

FIG. 6 illustrates initially configuring an EGM 604. Referring to FIG. 6, the download host server 602 communicates with the EGM 604 to remotely configure the EGM 604 options. In one embodiment, the download host server 602 may use the G2S optionConfig device to configure the EGM 604. However, any protocol capable of remotely configuring the EGM 604 options may be used. One skilled in the art knows how to select, and to design and implement such a configuration protocol, as appropriate.

FIG. 7 illustrates reconfiguring an operative EGM 704; that is, reconfiguring the EGM 704 after it had been configured and enabled 710 to allow play of a legacy game. Referring to FIG. 7, after initial configuration (FIG. 6), the download configuration server 702 may be controlled to change one or more game options. In the embodiment illustrated in FIG. 7, the download configuration host server 702 is controlled to change one option: the bet-per-line option from 5 to 10 credits 720 for the legacy game 708 in the EGM 704. As described above, the legacy game 708 is designed to set options only on installation, and not during operation. Consequently, to change options, the legacy game must be uninstalled and reinstalled, and the new options set at reinstallation time.
1. Before terminating the current installation of the legacy game 708, the OS 706 in the EGM 704 stores 725 current values of game play history logs, and accounting information in archive storage to preserve the current critical information needed to resolve any player disputes. This is described in more detail in FIG. 9, FIG. 10, FIG. 11, FIG. 12, FIG. 13, FIG. 14, FIG. 15, FIG. 16 and the associated written description, below.

Entries in the game descriptor file (FIG. 3, 308) allow configuration of the options of the legacy game, as described below. More specifically, an entry in the game descriptor file 308 related to the minimum bet option allows the download and configuration host server 702 to specify this option and the OS 706 to change this option in the legacy game 708. The minimum bet option is an integer type option with a maximum range defined in credits. Changing the value of this option in the EGM 704 may require that certain “Number of Lines” or “Bet per Lines” buttons on the button deck panel be disabled and force the player to bet a different minimum wager per game cycle.

For example, referring to FIG. 8a, if the initial configuration sets the minimum bet to $0.01, all the number-of-lines and bet-per-line buttons are enabled. Referring now to FIG. 8b, if an operator at the download and configuration host changes the value of the minimum bet option from $0.01 to $0.05, the OS 706 disables the four lowest bet-per-line buttons, based on an algorithm in the OS 706, so that the bet-per-line buttons displayed and enabled are the only choices players can select. In the algorithm in the OS 706, the game display defaults to maximum number of lines in this case. As illustrated in FIG. 8b, the 1-4 line buttons 802 are disabled and blank icons 804 are displayed instead.

These files are named as illustrated in FIG. 9. The display ID is 0 for a primary display, and 1 for a secondary display, and so forth; i.e. further digits may be assigned to represent other displays. The data/time stamp represents the date and time of creation of the file. The file extension, “f32” indicates that the file is an .f32 movie so appropriate programs may be invoked to properly read and process it.

The process of capturing the game history screens is similar to that of setting game options of a legacy game by the OS. That is, touch coordinates for the screen buttons and/or other widgets operative to display screens containing game history are stored in the game descriptor file (FIG. 3, 308). These coordinates are used by the OS to simulate navigating to the game history screens displayed by the legacy game. When a history item is displayed, frame-by-frame screen captures are performed and written to the named .f32 file. The “History” section of the Game Descriptor File describes the information necessary for performing the history navigation and recoding process.

In general, access to the display screens available for saving the game play history and accounting history of the EGM begin with screen 1000, illustrated in FIG. 10. On screen 1000, activating the “Archives” button 1006 displays a different screen, e.g. screen 1100 as illustrated in FIG. 11. Screen 1100 is typical of those screens containing history information. On screen 1100, a base game screen 1101 is shown in the foreground while a top screen 1003 is shown layered in the background. The buttons required to navigate and view the archived history are displayed on screen 1100 as follows. A Next button 1102 is activated to display to the next game history record. The Next button 1102 is grayed out, and inactivated, if no more game history records exist past the current one. A Previous button 1104 is activated to display the previous game history record. The Previous button 1104 is grayed out, and inactivated, if no more game history records exist prior to the current one. A Swap button 1006 is activated to swap between displaying the base game screen 1101 in the foreground and displaying the top screen 1103 in the foreground, if both are available. The Swap button 1106 is grayed out if no top screen history was captured for this game. A Features button 1108 is activated to show the current game's feature history if it exists. The Features button 1108 is grayed out if no features were played for this game history record. An Exit button 1110 is activated to close the Archived Game History screen 1100 and return to the screen 1000 of FIG. 10.

In automatic operation under control of the OS 706 (FIG. 7), the OS 706 simulates operation of the Archives button 1006 (FIG. 10), which controls the legacy game to display the archived game history screen 1100, illustrated in FIG. 11. The OS 706 captures data representing the image of the screen, then generates data representing a video frame containing the captured image, and appends the generated video frame to the video file designated as illustrated in FIG. 9. If a top screen 1103 exists, the OS 706 simulates activation of the swap button 1106, displaying the top screen in the foreground. Data representing the image of the displayed top frame is captured and appended to the video file in the same manner. The OS 706 then simulates activation of the Next button 1102, causing the next archived screen image, or images, to be displayed. These screen images are appended to the video file as just described. This continues until there are no further archived game play history screens to display, signified by the Next button 1102 being made inactive.

In order to save the features history of the legacy game, the OS 706 (of FIG. 7) then simulates activating the features button 1108 (of FIG. 11). This controls the EGM to display a features history screen 1200, illustrated in FIG. 12, including a main screen 1204 in the foreground and another screen 1206 layered behind the main screen 1204. The OS 706 captures the displayed screen 1204 and appends it to the video file. In some games the top screen 1206 is used to display additional game history information. In such cases, the OS 706 displays screen 1206 by simulating activation of the Swap button 1214. For example, FIG. 13 illustrates a display of the top screen 1306 of feature game history. The OS 706 captures screen 1306 and appends it to the video file. The OS 706 then advances to the next screen in the history by simulating activation of the Next button 1208. Subsequent feature history screens are captured and appended to the video file as just described. This continues until there are no more feature history screens. At this point the OS 706 simulates activation of the Exit button 1110, closing the Feature History screen 1100 and reopening the screen of FIG. 10.

The OS 706 then simulates activation of the current history button 1004 (of FIG. 10) which displays a current history screen similar to the archived history screen 1100 of FIG. 11 displaying the current game history. The same procedure of repeated screen capturing, appending to the video file, and swapping is performed to append frames representing the current game play history, and game feature history, to the video file. When there are no further current game play history screens to display, the Exit button is activated by the OS 706 closing the Current Game History screen and reopening the screen of FIG. 10.

Screens representing OS information are captured by the same technique described above: the OS 706 (FIG. 7) simulates activation of appropriate on-screen buttons and/or widgets, captures screen images and appends those screen images to a portion of a video file representing a frame. Referring again to FIG. 10, current OS information is accessed the OS 706 simulating activation of the “Accounting” button 1008 for the accounting data, and “History” button 1010 for the history data.

When the OS 706 (FIG. 7) simulates activation of the Accounting Button 1008 (FIG. 10), a screen 1400, illustrated in FIG. 14, is displayed. Archived OS information is then accessed by the OS 706 simulating activation of the “Archives” button 1402. In response to activating the “Archives” button 1402, a screen 1500, illustrated in FIG. 15, is displayed including a list box 1502. One of the items from the list box may be selected to view. For example, in order to display the accounting information, the OS 706 simulates activating the Security Accounting entry 1504. In response, a screen, as illustrated in FIG. 16, is displayed. This screen displays a portion of the accounting data. The OS 706 captures image data representing this screen and appends it to the video file, as described above. The OS 706 (FIG. 7) simulates activation of a Next button 1602. In response, the EGM is controlled to display the next screen of accounting information. This screen is captured and appended to the video format file. This is repeated until the next button 1602 is grayed out, indicating that no more accounting data exists past the current screen.

FIG. 17 and FIG. 18, together, are a listing of an exemplary game descriptor file (308 of FIG. 3). Data in this file is used by the OS 706 (FIG. 7) to simulate activation of appropriate screen buttons, list entries, and/or other widgets. In general, when an operator activates an on-screen button, the operating system generates data representing the button activation. This data is stored in a construct sometimes called an event. The data in the event includes data representing the location touched, which button was activated, and so forth. The event data is supplied to different software routines which react to the received event by performing some processing. For example, pressing the Game Play History button 1002 (FIG. 10) generates an event which causes the legacy game software to display the game play history screen 1100 (FIG. 11) to be displayed. The OS 706 simulates activation of the Game Play History button 1002 by generating an event which contains the same data as an event which would have been generated by an operator activating the button. This event is then distributed to the rest of the system in the same manner as a normal, operator generated, event would be. The system then responds as if the Game Play History button 1002 had been activated by an operator.

The game descriptor file of FIG. 17 and FIG. 18, contains the information required by the OS 706 (FIG. 7) to generate the events which simulate activation of the required buttons, list entries, and/or other widgets. Referring specifically to FIG. 17, as may be seen, after identifying the descriptor type 1702 and part number 1704, the game descriptor file lists a series of features of the legacy game to be accessed by the OS. For example, “history” 1706 and “options” 1708. Within the history record 1706 are items 1710, 1712, 1714 and 1716, indicating button types and locations. More specifically, item 1710 describes a button having the type “enter”, text “feat1”, and screen location x=0.777187 and y=0.032564. When the OS 706 desires to activate this button, it assembles a button-press event using this data from the GDF, and passes that event to the legacy game, simulating activation of this button. Other items in the game descriptor file FIG. 17 and FIG. 18 provide required data to the OS 706 for it to simulate activation of the other buttons, list entries, etc. This data is used by the OS 706 to navigate through the legacy game menu screens as described above.

What is claimed is:

1. An improved system for configuring a gaming machine having an operating system to operate a legacy game image software of the type (i) configured to operate said legacy game on a legacy gaming device and (ii) to control a legacy gaming device display to display one or more configuration screens displaying interface buttons or widgets for an operator to configure one or more configurable features at a said legacy gaming device, said system comprising:
a host server having access to a data file containing (a) said legacy game image software and (b) game descriptor software configured to control said operating system to simulate the operator interface with said buttons or widgets of said one more configuration screens of said legacy game software for configuration said one or more features of the legacy game at said gaming machine;
a communication network between said host server and said gaming machine; and
one or more of said host server and gaming machine configured to download said data file over said network to said gaming machine for presentation of the configured legacy game at the gaming machine.

2. The improved system of claim 1 comprising said host server configured to combine said game image software and said game descriptor software into a download package.

3. The improved system of claim 1 comprising said package including a cryptographic signature.

4. A method for configuring a gaming machine having an operating system to operate a legacy game image software of the type (i) configured to operate said legacy game on a legacy gaming device and (ii) to control a legacy gaming device display to display one or more configuration screens displaying interface buttons or widgets for an operator to configure one or more configurable features at a said legacy gaming device, said method comprising:
configuring a host server to access to a data file containing (a) said legacy game image software and (b) game descriptor software configured to control said operating system to simulate an operator interfacing with said buttons or widgets of said one more configuration screens of said legacy game software for configuration said one or more features of the legacy game at said gaming machine;
enabling said host server to communicate through a communication network to said gaming machine;
providing for the download said data file over said network to said gaming machine for presentation of the configured legacy game at the gaming machine.

5. The method of claim 4 comprising configuring said host server to combine said game image software and said game descriptor software into a download package.

6. The method of claim 5 comprising cryptographically signing said download package.
